(19) United States
(12) Patent Application Publication
(10) Pub. No.: US 2023/0329256 A1
(43) Pub. Date: Oct. 19, 2023

(54) SMOKER DEVICE WITH ENHANCED BURN AREA

(71) Applicant: Thousand Oaks Barrel Co., Manassas, VA (US)

(72) Inventor: Bryan Weisberg, Ashburn, VA (US)

(73) Assignee: Thousand Oaks Barrel Co., Manassas, VA (US)

(21) Appl. No.: 17/723,573

(22) Filed: Apr. 19, 2022

(51) Int. Cl. A23B 4/052

(52) U.S. Cl. CPC A23B 4/052

(57) ABSTRACT

The invention includes a device for imparting smoked flavors to beverages and foodstuffs that can include a base having at least a side wall, a top surface, and a bottom surface, a recessed hole in the top surface of the base, and a removeable bung that can be partially received by the recessed hole. The bung includes a pyro surface of cut lines in a surface of the bung that enhances ignition of the pyro surface by an external flame.

### BACKGROUND

Alcoholic beverages such as cocktails are traditionally either served neat, over ice, or blended with juice or other mixing agents. For many spirits such as whiskey, flavors are traditionally added by introducing the distilled spirit into American Oak or other types of barrels, where color, sweetness, wood flavors, and smoke flavors from charcoal are infused from the wood into the spirit.

Many bartenders and beverage managers in the past few years have been offering a “smoked” alcoholic beverage to their customers. The vast majority of the types of distilled spirit used in a smoked cocktail are whiskeys and tequila or mezcal. Prior devices have been commercialized that can impart smoky and spicy flavors into individually-served alcoholic beverages in order to replicate the flavors of “aging” a spirit in a barrel. For example, hand-held or “bartop” smokers consist of a glass box in which a drinking glass can be enclosed. Wood chips are placed in a screen within a torch device and a hose connects the torch device securely into the glass box. As the torch is lit, it burns wood fuel and smoke pours through the hose into the box, thereby filling the box with smoke and adhering smoke to the drinking glass and infusing smokey flavors into the beverage. This device has many limitations, however, such as a time consuming task of having to clean the glass box after each use and adhering smokey residue (and flavors) to the outside of the drinking glass that can be transmitted onto the drinker's hands.

Another device that has been commercialized uses a cut piece of flat wood that may optionally have a circular groove carved into the piece that will accept a glass rim. Some bartenders refer to these devices as “planks.” A center portion of the plank is lit on fire with a torch, and an empty glass is then inverted and placed over the flame. Smoke from the burning wood can fill the glass, which is then removed after smoking completes.

However, these cocktail smoking planks have a number of drawbacks and shortcomings. For example, over time the multiple burning of the same area of a plank will create almost a glassy surface on the wood that is very difficult to burn evenly or to even create a satisfactory burn and smoke at all. The wood can also crack and turn to ash, for which there is no proper mechanism or method for cleaning or clearing the burned areas provided to the user. Another shortcoming of prior devices is that once a plank has been burned multiple times and the wood begins to thin and/or crack and turn to charcoal or ash in the burned area, the wood device will break and therefore reach the end of its life. Thus, the entire device must be discarded even though the wood surrounding the burned area is still intact. Another drawback to using a plank to smoke cocktail glasses is that only a single profile of smoke flavor from the wood can be imparted to the glass. There is no option available to create custom flavor profiles using other wood fuel sources, since the plank is simply a single piece of wood.

Another problem with many of the current devices is the type of wood used for the planks. Most current planks use furniture-grade wood, which is a lower quality of wood than bourbon-barrel quality wood that originates from harvested American White Oak trees. For example, individuals who drink bourbon are keen to recognize flavors imparted to whiskey from barrels of American White Oak wood. The lower-quality wood used in planks will not have the same flavor profiles that bourbon drinkers will expect.

The disclosed systems and methods are directed to overcoming one or more of the shortcomings set forth above and/or other shortcomings of the prior art.

### SUMMARY

There is a need for a device to impart smokey and other flavors through a flow of smoke into an alcoholic beverage glass and foodstuffs under a cloche that overcomes the problems recognized above and other problems and shortcomings of the prior art.

In one aspect of the disclosure, a device for imparting smoked flavors to beverages and foodstuffs is disclosed that can include a base having at least a side wall, a top surface, and a bottom surface, a recessed hole in the top surface of the base, and a removeable bung that can be partially received by the recessed hole. The bung includes a pyro surface of cut lines in a surface of the bung that enhances ignition of the pyro surface by an external flame.

In another aspect, the recessed hole is formed with a circular wall in the base, and wherein the bung is formed with a circular wall that is partially received by the recessed hole. In some aspects, the bung circular wall is sloped at an angle such that a bung bottom surface diameter is less than a bung top surface diameter. In addition, the cut lines are repeated across a top surface of the bung. In another aspect, the cut lines are spaced at least one eighth of an inch apart from one another. Another aspect includes a scraper device. The scraper device includes a scraping surface on an end of the scraper device. The scraper device is partially received into a scraper device hole in the base.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 illustrates a perspective view of an embodiment for a smoker device;

FIG. 2 illustrates a first side view for the smoker device of FIG. 1;

FIG. 3 illustrates a third side view of the smoker device of FIG. 1;

FIG. 4 illustrates a fourth side view of the smoker device of FIG. 1;

FIG. 5 illustrates a second side of a smoker device of FIG. 1;

FIG. 6 illustrates a top view of the smoker device of FIG. 1;

FIG. 7 illustrates a top view of the smoker device of FIG. 1 without a removable bung;

FIG. 8 illustrates a perspective view of the smoker device of FIG. 1 without a removable bung;

FIG. 9 illustrates an exploded perspective view of the smoker device of FIG. 1; and

FIG. 10 illustrates a side view of the removable bung of FIGS. 1 and 9;

FIG. 11 illustrates a top view of the removable bung of FIGS. 1 and 9;

FIG. 12 illustrates perspective view of an alternative embodiment of a smoker device; and

FIG. 13 illustrates a top view of the alternative embodiment of the smoker device of FIG. 12.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims. The present disclosure is to be considered as an exemplification of the invention and is not intended to limit the invention to the specific embodiments illustrated by the figures or description herein.

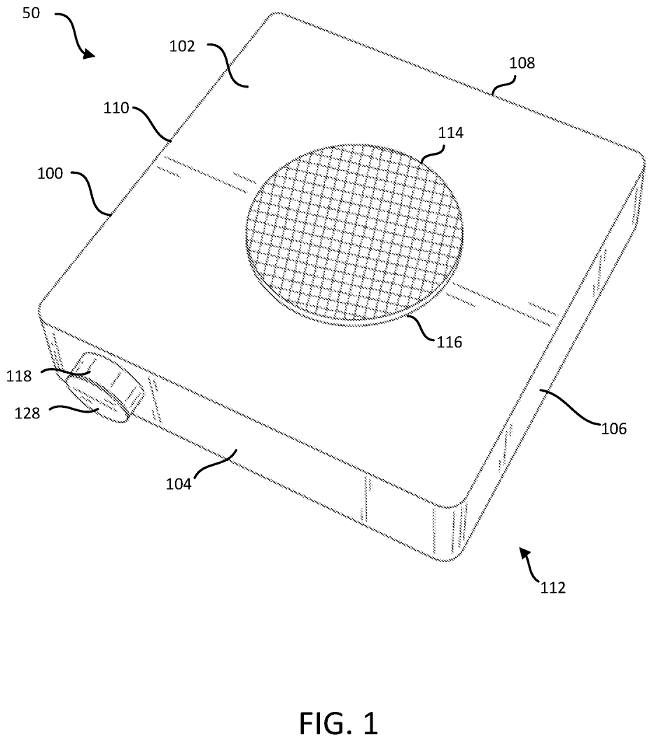

Referring to FIG. 1, an embodiment for a smoker device 50 with an enhanced burn area is illustrated in a perspective view. In an embodiment, the smoker device 50 can be formed in a generally square base 100, however, the embodiments are not limited to a square base 100 and the base 100 could be formed rectangular, irregular, circular, or any shape that will function according the claimed invention. The embodiment for the smoker device 50 can include the base 100 defined by a top surface 102, a first side wall 104, a second side wall 106, a third side wall 108 (not shown), and fourth side wall 110 (not shown) and a bottom surface 112 (not shown). An embodiment of the smoker device 50 with a squared base 100 can be advantageous to the user when handling the device. For example, squared shape with corners can be easier to hold with a firm grip than for example, a rounded shape, and can be less likely to slip out of a user's hands when working behind a bar making cocktails.

The smoker device 50 can also include an enhanced burn area that can be formed as a novel type of bung 114. In an embodiment, the bung 114 can be oriented to fit at a central location within top surface 102 of base 100. However, other embodiments can have orientations of bung 114 within top surface 102 in other locations such as top end, bottom end, offset, etc. In one embodiment, the bung 114 is embedded within base 100. In another embodiment, the bung 114 can be removably placed within base 100. The bung 114 should be oriented to provide adequate space on base 100 for a rim of an inverted drinking glass to be placed around bung 114 so that the glass can be stable without falling off of top surface 102 or likely to tip over. The bung 114 can be formed to be securely received by a bung hole 116 or recess into base 100 through the top surface 102.

The smoker device 50 can also include a cylindrically shaped scraper tool 118 that can be partially housed inside a recess or hole 120 of a wall, such as first side wall 104. In other embodiments, the scraper tool 118 may be housed or partially housed in other locations on the base 100 such as but not limited to top surface 102 or the second, third, or fourth side walls 106, 108, 110, respectively. In still other embodiments, the scraper tool 118 may be kept separate from the smoker device 50 thereby eliminating the need for a receiving hole for the scraping tool 118. The scraping tool 118 can include scraping surface 128 that may include, but is not limited to, sandpaper or other abrasive particles adhered or secured to a flat end of the cylindrical scraper tool 118.

In the embodiments, smoker device 50 can be constructed of materials such as wood, metal, resin, or any material that can withstand excessive heat caused by fire. However, bung 114 is preferably constructed of wood since the bung 114 is the enhanced burn area of the smoker device 50. In an embodiment, bung 114 is preferably constructed of wood from the American White Oak tree.

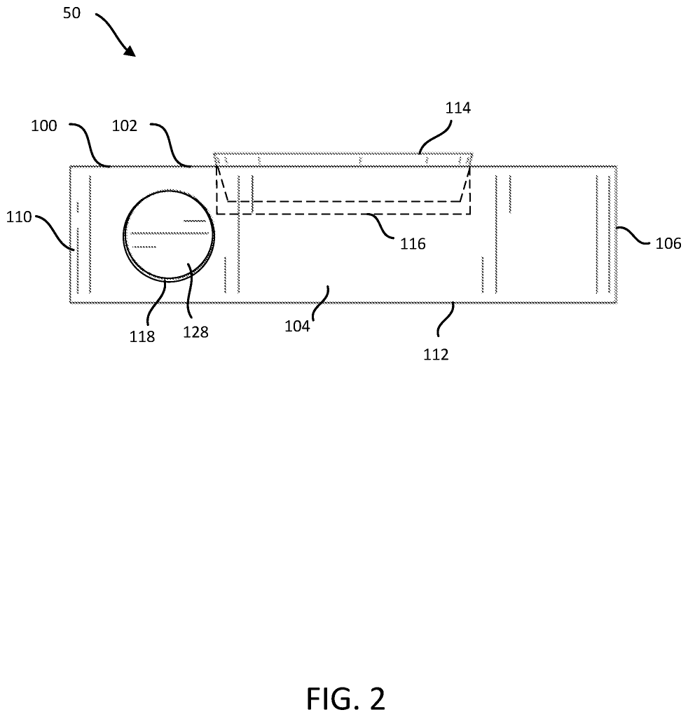

FIG. 2 illustrates a first side view of the exemplary smoker device 50 of FIG. 1. In an embodiment, the base 100 can be defined as including the first side wall 104, second side wall 106, third side wall 108 (not shown), and fourth side wall 110 that are bound on top and bottom ends by top surface 102 and a bottom surface 112, respectively. A height of the first side wall 104, second side wall 106, third side wall 108, and fourth side wall 110 can vary according to the embodiments, but in a preferred embodiment the height can vary between approximately one and two inches. Rising above top surface 102 is the bung 114, which is partially recessed below top surface 102 into bung hole 116. The scraper tool 118 is shown partially recessed into and oriented towards the left side of the first side wall 104.

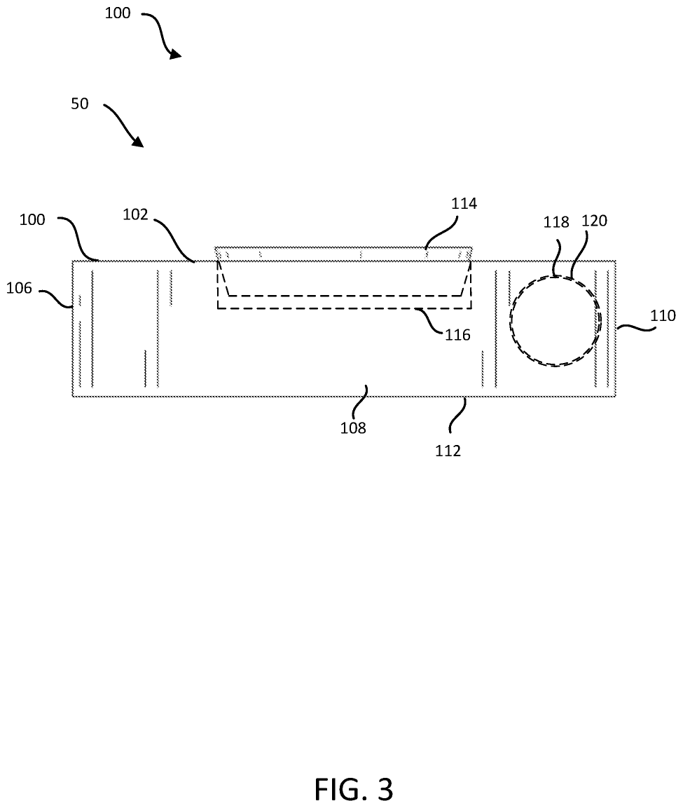

FIG. 3 illustrates a third side view of the exemplary smoker device 50 of FIG. 1. In FIG. 3, the base 100 is shown rotated on its vertical axis 180 degrees from the view in FIG. 2. The base 100 can include third side wall 108, second side wall 106, fourth side wall 110, and first side wall 104 (not shown) which are bound on the top and bottom edges by top surface 102 and bottom surface 112, respectively. The bung 114 is shown partially installed in the bung hole 116 and rising above top surface 102. Since the first side wall 104 is out of view, the scraper tool 118 is shown entirely in ghost lines and housed within scraper tool hole 120.

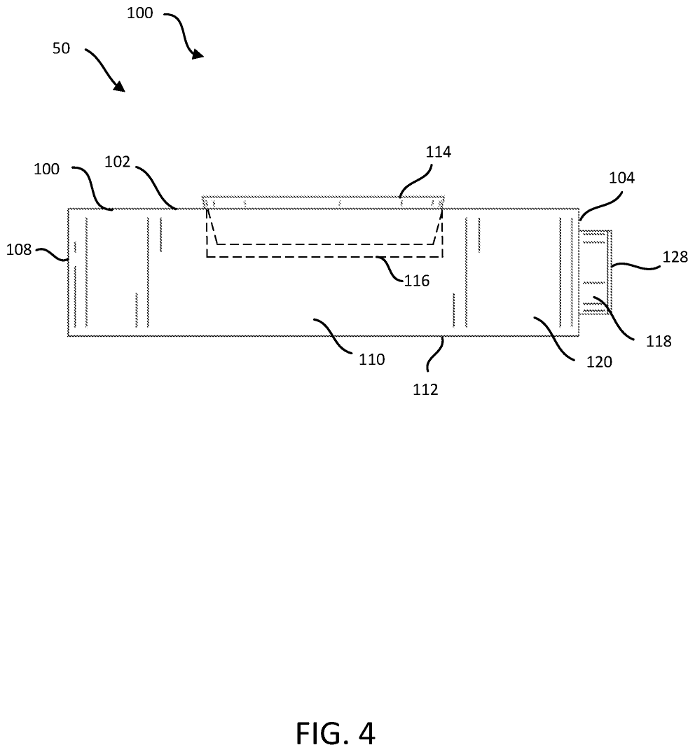

FIG. 4 illustrates a fourth side view of the exemplary smoker device 50 of FIG. 1. In FIG. 4, the base 100 is defined by the fourth side wall 110, second side wall (not shown), and the first and third side walls 104, 108, respectively. The bung 114 can be placed in the bung hole 116 and is shown partially rising above top surface 102 and partially recessed into bung hole 116. The scraper tool 118 with scraper surface 128 is shown partially extending away from the side wall 104 and partially recessed within scraper tool hole 120.

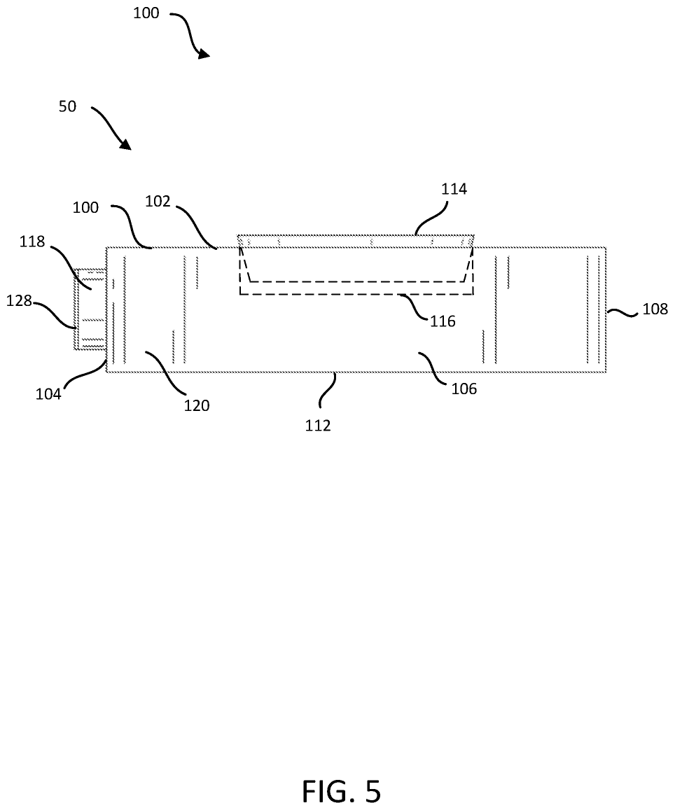

FIG. 5 illustrates a second side view of the exemplary smoker device 50 of FIG. 1. In FIG. 5, the base 100 is defined by the second side wall 106, the first and third side walls 104, 108, respectively, and the fourth side wall 110 (not shown) that are bound by upper surface 102 and bottom surface 112. The bung 114 is shown. The bung 114 is shown installed in the bung hole 116, partially rising above top surface 102 and partially recessed into bung hole 116. The scraper tool 118 with scraping surface 128 extends away from the side wall 104 and is partially recessed within scraper tool hole 120.

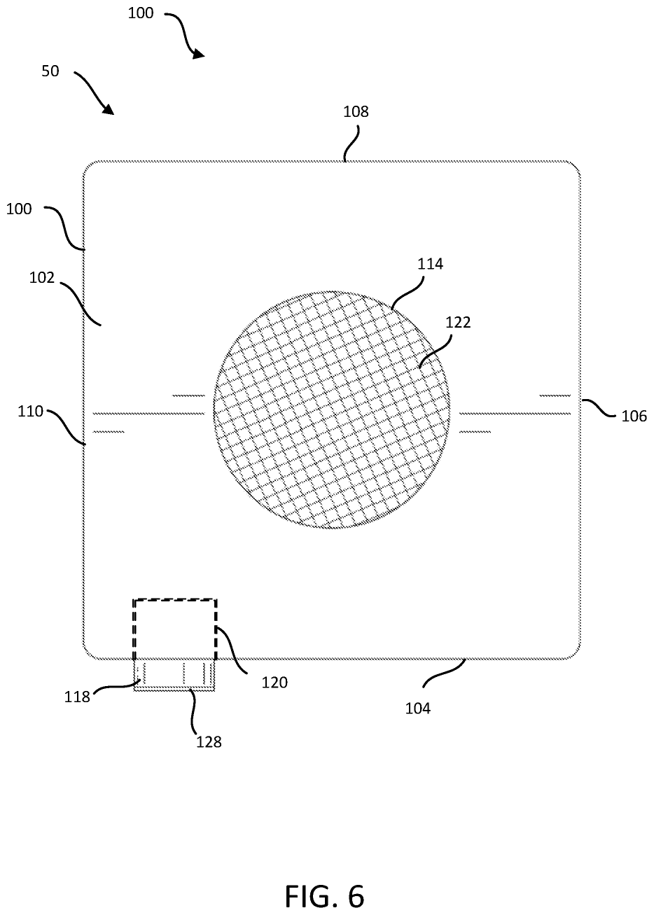

FIG. 6 illustrates a top view of the smoker device 50 of FIG. 1. In FIG. 6, the base 100 is defined by top surface 102, and the first, second, third, and fourth side walls 104, 106, 108, 110, respectively. The bung 114 can include a pyro surface 122, which is shown as an exemplary crosshatch pattern. The scraper tool 118 with scraping surface 128 partially extends away from the side wall 104 and is partially recessed within scraper tool hole 120 in side wall 104.

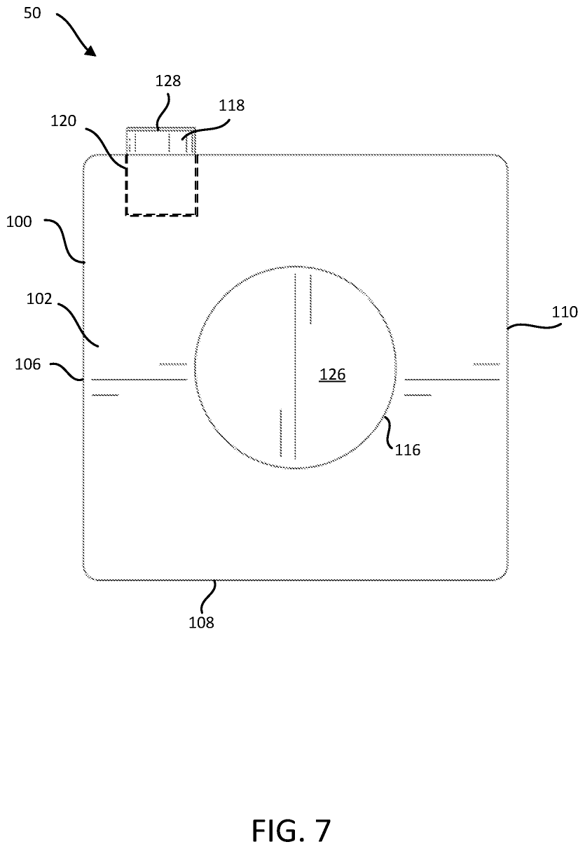

FIG. 7 illustrates a top view of the exemplary smoker device 50 of FIG. 1 without the removable bung 114. In an embodiment, FIG. 7 shows the base 100 defined by the top surface 102 and the first, second, third and fourth side walls 104, 106, 108, 110, respectively. Bung hole 116 can be defined as a circular recess into top surface 102. The bung hole extends partially, but not fully through, top surface 102 creating a hollow area that can be capable of holding wood chips. Although the exemplary bung hole 116 is shown in FIG. 7 oriented at a central area of top surface 102, in other embodiments the bung hole 116 could be oriented at any location on surface 102 that could function as a location for smoking beverage glasses. The scraper tool 118 with scraping surface 128 is shown partially extending away from the side wall 104 and in ghost lines partially recessed within scraper tool hole 120.

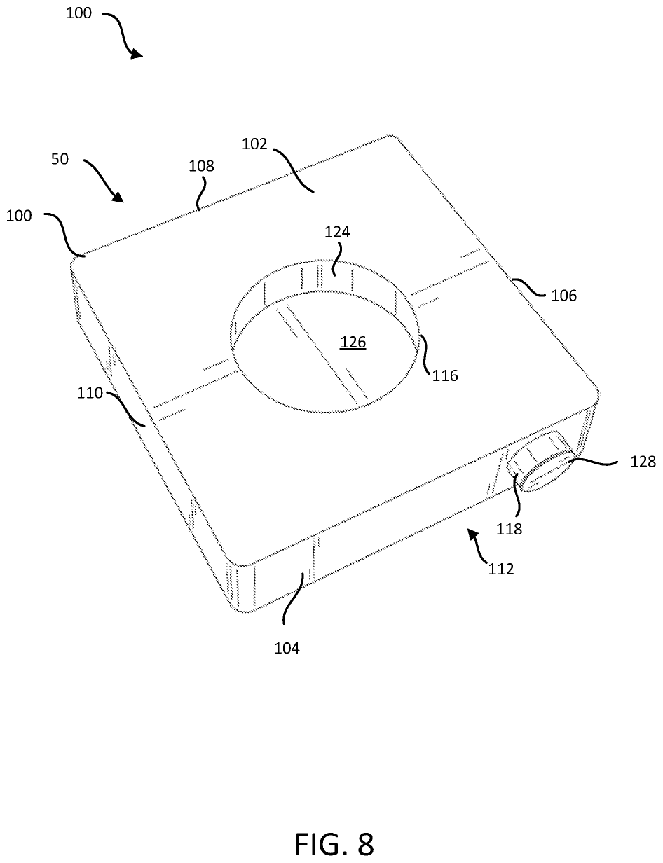

FIG. 8 illustrates a perspective view of the exemplary smoker device 50 of FIG. 1 without the removable bung 114. FIG. 8 shows the base 100 defined by top surface 102, first side wall 104, second side wall 106 (hidden), third side wall 108 (hidden) and fourth side wall 110. The scraper tool 118 with scraping surface 128 is partially recessed into hole 120 in the first side 104 and a portion protruding from the first side 104. Scraping surface 128 may include, but is not limited to, sandpaper or other abrasive particles adhered or secured to a flat end of the cylindrical scraper tool 118. The bung hole 116 is shown as a circular recess cut into the top surface 102, extending to a depth defined by bung hole wall 124 and bung hole floor 126. One skilled in the art will recognize that the geometric shape of the bung hole 116 can vary and is not limited to a circular hole, and other embodiments for bung hole 116 can match or mimic alternative shapes of bung 114.

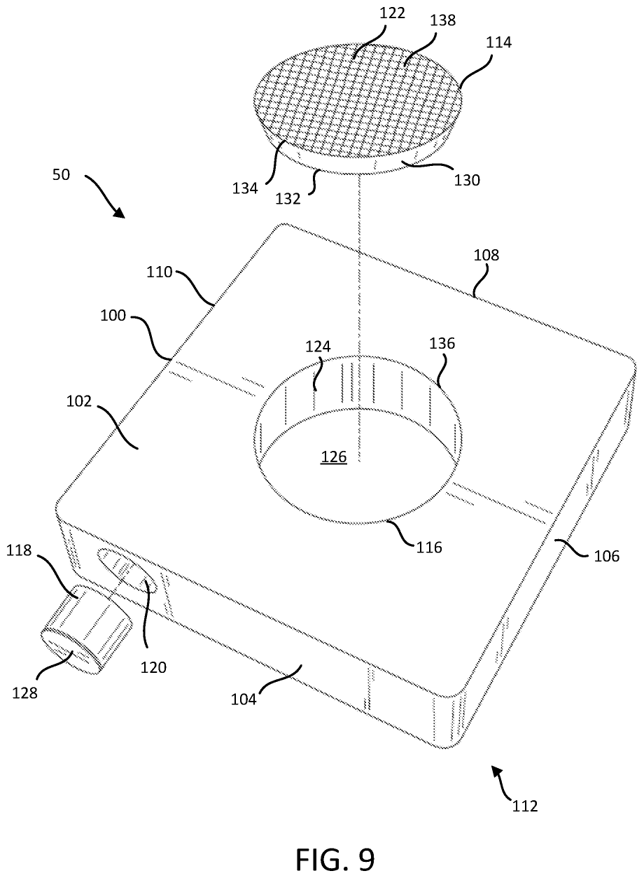

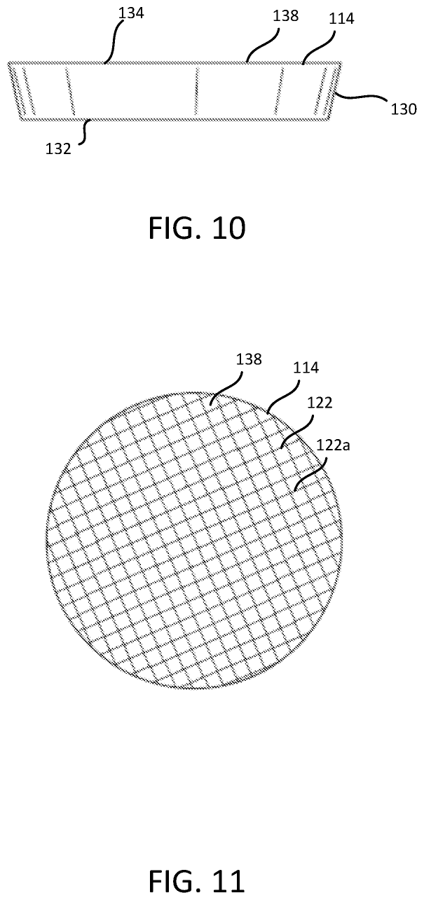

FIG. 9 illustrates an exploded perspective view of the smoker device 50 of FIG. 1. FIG. 8 shows the base 100 defined by top surface 102, first side wall 104, second side wall 106, third side wall 108 and fourth side wall 110. The scraping tool 118 with scraping surface 128 mounted on an end is shown extended fully outside of scraper tool hole 120 in the first side 104. The bung hole 116 is shown as a circular cut into the top surface 102, extending to a depth defined by wall 124 and floor 126. Referring also to FIGS. 10 and 11, the bung 114 can be defined by a sloped cylindrical wall 130 that can be defined by a top end 134 and a bottom end 132. In an embodiment, due to the angle of the sloped wall 130, the diameter of top end 134 is larger than a diameter of bottom end 132. Furthermore, in order to fit bung 114 securely into bung hole 116, the diameter of sloped wall top end 134 is greater than a diameter of bung hole 116, and the diameter of sloped wall bottom end 132 is less than the diameter of hole 116. In a preferred embodiment, a diameter at a point on sloped wall 130 between the top end 134 and the bottom end 132 should approximate the diameter of hole 116. When placing the bung 114 into bung hole 116, the sloped wall 130 will contact a top edge 136 of bung hole 116. The bung 114 may inserted into bung hole 116 bottom end 132 first in order to force-fit the bung 114 into the bung hole 116. The bung 114 can be secured in bung hole 116 due to the friction of the sloped wall 130 against the top edge 136. FIGS. 1-5 illustrate this force-fit insertion of bung 114 into bung hole 116. In an embodiment, a perpendicular height of sloped wall 130 is preferably less than the height of bung hole wall 124, which will provide adequate space for the placement and replacement of bung 114 into bung hole 116 during use of the smoker device 50.

The smoker device 50 can provide a user with multiple embodiments to add smoke to an inverted cocktail glass using an enhanced burn area. In one embodiment, the pyro surface 122, which is manufactured from wood, can be ignited by a flame, such as a from a butane torch or chef's torch, that will ignite the pyro surface 122 thereby causing smoke to emanate from the pyro surface 122. Current devices to add smoke to a cocktail glass, such as planks, can be manufactured from undesirable wood such as treated oak, also known as furniture grade wood. Some wood meant for furniture may have chemicals in it or is softer wood not desirable for repeated ignition over time. Furthermore, traditional wooden bungs are made from pine wood. When ignited to cause smoke for a glass, pine wood will not provide proper flavor notes that drinkers of distilled spirits desire. The bung 114 of the embodiments is preferably manufactured from high quality wood from the American White Oak tree meant for bourbon barrels, which is premium, “barrel-quality” wood. “Barrel-quality” wood has also been dried extensively before use to remove moisture from the wood. The high quality of the wood in the bung 114 therefore can provide a longer-lasting pyro surface 122 and can provide higher quality smoke for beverage glasses. Smoke emanating from burning barrel wood can provide the flavor notes that drinkers of distilled spirits expect and desire.

Another novel aspect of the exemplary bung 114 is its dimensional thickness. The height of bung 114, defined by sloped wall 130, is approximately half the thickness of a comparatively sized traditional wood bung. In one embodiment, the height of bung 114 is approximately one half of a inch. However, this height dimension is merely exemplary, and other heights of bung 114 are within the scope of the invention. Since the bung 114 does not have a great height profile, the bung hole 116 does not need a great depth profile. An additional novel aspect of the exemplary bung 114 is the receding angle of sloped wall 130. Tests were performed on differing sloped angles of the sloped wall 130 to determine an optimal slope angle that could hold the bung 114 tightly into bung hole 116 without coming loose due to extreme heat and cooling causing expansion and contraction of the pyro surface 122 over multiple uses. Tests concluded that a sloped angle between approximately 15 and 30 degrees of sloped wall 130 provided an optimal secure fit of bung 114 into bung hole 116. However, the skilled artisan will recognize that other angles of sloped wall 130 could be used with other embodiments depending on dimensions of the bung 114, hole 116, and the type of wood used to make the bung 114 and smoker device 50, and remain within the scope of the invention. Another advantage to the exemplary dimensions of the bung 114 is that when a user inserts bung 114 into bung hole 116, the sloped wall 130 can gently slide into bung hole 116 after contacting the top edge 136 of bung hole 116, which can prevent breakage and splintering of the top edge 136 into hole wall 124. This exemplary construction of the sloped wall 130 will also prevent the wall 130 from an excessive amount of contact with the perpendicular oriented bung hole wall 124, which also can prevent breakage and splintering of the bung hole wall 124 and bung wall 130.

In the embodiments, providing a removable and replaceable bung 114 has many advantages. Over time, after thousands of uses by ignition of the pyro surface 122 and cleaning of the pyro surface 122 by scraping device surface 128, the pyro surface 122 may wear down or otherwise become unusable. Instead of replacing an entire smoking device 50, the user may simply replace the worn bung 114 with a new bung. This creates a very convenient and cost-effective solution for users over the prior devices, which must be replaced in total when the burn area is worn out. The user can continue to use the smoker device 50 by replacing a single inexpensive piece instead of the entire unit.

In the embodiments, a top surface 138 of bung 114 can include the pyro surface 122 appearing in a grid-like pattern (see FIG. 11). Each grid line shown is a cut line 122a made into the top surface 138 of bung 114. The purpose of the cut lines 122a are to expose as much surface area of the top surface 138 of bung 114 as possible in order to create a pyro surface 122 that will ignite faster than would a solid surface of wood without any cuts. An advantage to this design is that a user does not need to hold a high-temperature torch to the pyro surface for more than a few seconds in order for the pyro surface to ignite, thereby preventing the pyro surface 122 and entire bung 114 from exposure to higher temperatures than is necessary. In one embodiment, the pyro surface 122 can ignite in less than a second—nearly instantaneously—when a chef's butane torch is applied. The exemplary design can thus help prevent extreme swelling of the bung 114 due to overheating from extending contact with flames from a torch and then subsequent shrinkage back to room temperature, thereby extending the life of the bung 114 and pyro surface 122. An advantage to having the bung 114 rise partially above the smoker device top surface 102 (see FIGS. 2-3) is to provide an elevated pyro surface 122 for a user to direct a torch or other flame onto when igniting the pyro surface 122. The design minimizes flames from the pyro surface contacting the top surface 102 when the pyro surface 122 is burning including minimizing the top end 136 of bung hole 116 from burning, breaking, and wearing out, which could prevent the bung 114 from seating and securing into bung hole 116 properly.

In the embodiments, it is preferable to expose as much surface area of the pyro surface 122 as possible with as many cuts 122a as is practical. Testing of different dimensions of the cuts 122a found that, in general, if the cuts 122a are formed too close together in a tight grid pattern, the top ends of the wood remaining between the cuts 122a burns off quickly. In an embodiment, tests confirmed that spacing of approximately one eighth (⅛) of an inch between parallel cuts 122a was the optimal distance to provide optimal time for ignition of the wood between the cuts 122a and to avoid igniting and the top ends of the remaining top surface 138 between the cuts 122a. In the experiments, cuts 122a of 1/32 an inch caused the wood on top of the cuts 122a to burn off quickly, and cuts 122a of greater than ⅛ of an inch between the cuts 122a caused the wood within the cuts 122a too ignite too slowly and did not provide an optimal flame in order to create optimal smoke production. At a distance of ⅛ of an inch, the cuts 122a allowed the wood in the sloped or perpendicular exposed spaces within the cuts 122a to ignite nearly instantaneously, or at least within a few seconds.

A skilled artisan will recognize that the grid pattern of cuts 122a is exemplary and the cuts 122a could be made in other patterns or designs such as, but not limited to, single parallel patterns, circular patterns, zig-zag patterns, etc., and still function according to the embodiments. The depth of cuts 122a is also exemplary and can vary according to the embodiments. The depth of cuts 122a into the pyro surface 122 should be less than the height of sloped wall 130 in order not to cut through bung 114. In an exemplary embodiment, a depth of cuts 122a may be between approximately ⅛ to ½ the thickness of bung 114 to function optimally. However, the skilled artisan will recognize that other depths are possible to function according to the embodiments.

The exemplary design for the pyro surface 122 has another advantage for bar and restaurant venues where bartenders work quickly to fulfill drink orders: the fast ignition of the pyro surface creates efficiency for a bartender using the smoker device 50. In an equivalent time it would take the bartender to ignite and use a prior plank device to fill a single order for a smoked cocktail, the same bartender could smoke and fill multiple beverage glasses used to fulfill orders of smoked cocktails.

In another embodiment, the smoker device 50 may be used to add smoke to an inverted cocktail glass without the use of the pyro surface 122 of the bung 114. FIGS. 7 and 9 illustrate the smoker device 50 with the bung 114 removed from bung hole 116. In this embodiment, shaved wood or chips may be placed into bung hole 116 and used as fuel. The fuel can be ignited using a chef's torch, lighter, or any appropriate ignition device, thereby causing smoke to rise from the ignited fuel so that an inverted glass over the bung hole 116 can fill with smoke.

In some embodiments, after the smoker device 50 has been used multiple times, for example hundreds of times, the wood at the top of cuts 122a of pyro surface 122 may begin to ignite, burn, and break off. When this occurs, the scraper tool 118 can be used by applying scraping surface 128 to the pyro surface 122 in sanding manner, to sand the burnt tops between cuts 122a. The result of sanding the pyro surface 122 using scraper tool 118 can be to expose fresh wood at the top of pyro surface 122 between cuts 122a. This exemplary process can be repeated as needed by a user to extend the life of the pyro surface 122 as an enhance burning area of the smoker device 50.

In other embodiments, the smoker device 50 can be used to add smoky flavors to food and sauces using similar methods as those described herein. The pyro surface 122 can be ignited to initiate smoke emanating from the wood. The smoker device can be placed next to the food, such as on a charcuterie board, and a glass cloche placed over the food and smoker device 50. Smoke from the smoker device can fill the cloche and impart smoky flavor to the food or sauce placed under the cloche.

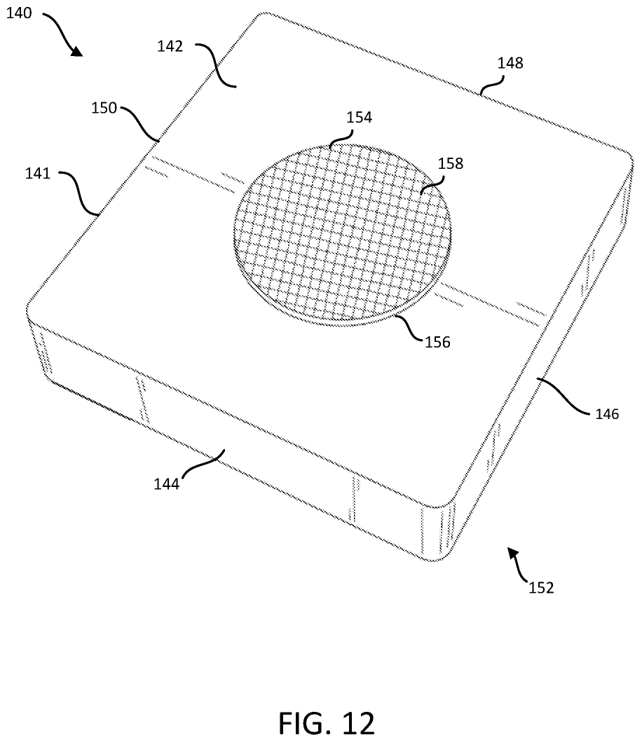

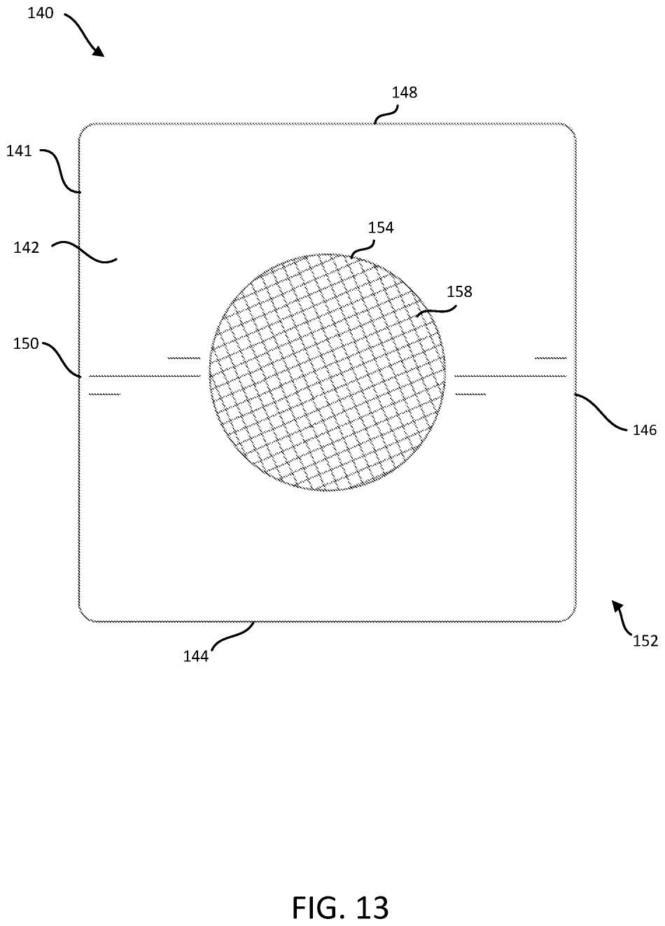

FIG. 12 illustrates perspective view of an alternative embodiment of a smoker device, and FIG. 13 illustrates a top view of the alternative embodiment of the smoker device of FIG. 12. An alternative embodiment of the smoker device 50 with an enhanced burn area is shown as smoker device 140. Alternative smoker device 140 is similar in most respects to the smoker device 50 except that the alternative embodiment does not include the scraper tool 118 fit into the scraper hole 120 in the smoker device 140. The scraper tool 118 may be provided to a user separately other than fitted into the alternative smoker device or not be included at all. In the alternative embodiment, the smoker device 140 can be formed in a generally square base 141, however, the embodiments are not limited to a square base 141 and the base 141 could be formed rectangular, irregular, circular, or any shape that will function according to the claimed invention. The embodiment for the alternative smoker device 140 can include the base 141 defined by a top surface 142, a first side wall 144, a second side wall 146, a third side wall 148, and fourth side wall 150, and a bottom surface 152 (not shown). The alternative embodiment of the smoker device 140 with a squared base 141 can be advantageous to the user when handling the device. For example, squared shape with corners can be easier to hold with a firm grip than for example, a rounded shape, and can be less likely to slip out of a user's hands when working behind a bar making cocktails.

The alternative smoker device 140 can also include an enhanced burn area that can be formed as a novel type of bung 154 with pyro surface 158. In an embodiment, the bung 154 can be oriented to fit at a central location within top surface 142 of base 141. However, other embodiments can have orientations of bung 154 within top surface 142 in other locations such as top end, bottom end, offset, etc. In one embodiment, the bung 154 is embedded within base 141. In another embodiment, the bung 154 can be removably placed within base 141. The bung 154 should be oriented provide adequate space on base 141 for a rim of an inverted drinking glass to be placed around bung 154 so that the glass can be stable without falling off of top surface 142 or likely to tip over. The bung 154 can be formed to be securely received by a bung hole 156 or recess into base 141 through the top surface 142.

In alternative embodiment, smoker device 140 can be constructed of materials such as wood, metal, resin, or any material that can withstand excessive heat caused by fire. However, bung 154 is preferably constructed of wood since the bung 154 is the enhanced burn area pyro surface 158 of the smoker device 140. In an embodiment, bung 154 is preferably constructed of wood from the American White Oak tree.

It will be apparent to those skilled in the art that various modifications and variations can be made to the disclosed IoT data compression system and method. Other embodiments will be apparent to those skilled in the art from consideration of the specification and practice of the disclosure. It should be appreciated that different embodiments and different features of embodiments can be used with other embodiments. It is intended that the specification and examples be considered as exemplary only, with a true scope being indicated by the following claims and their equivalents.

What is claimed is:

1. A device for imparting smoked flavors to beverages and foodstuffs, comprising:
a base having at least a side wall, a top surface, and a bottom surface;
a recessed hole in the top surface of the base; and
a removeable bung that can be partially received by the recessed hole,
wherein the bung includes a pyro surface of cut lines in a surface of the bung that enhances ignition of the pyro surface by an external flame.

2. The device of claim 1, wherein the recessed hole is formed with a circular wall in the base, and wherein the bung is formed with a circular wall that is partially received by the recessed hole.

3. The device of claim 2, wherein the bung circular wall is sloped at an angle such that a bung bottom surface diameter is less than a bung top surface diameter.

4. The device of claim 1, wherein the cut lines are repeated across a top surface of the bung.

5. The device of claim 4, wherein the cut lines are spaced at least one eighth of an inch apart from one another.

6. The device of claim 1, further comprising a scraper device.

7. The device of claim 6, wherein the scraper device includes a scraping surface on an end of the scraper device.

8. The device of claim 6, further comprising a scraper device hole in the base, wherein the scraper device is partially received into the scraper device hole.
